(19) United States
(12) Patent Application Publication
(10) Pub. No.: US 2022/0361073 A1
(43) Pub. Date: Nov. 10, 2022

(54) COMMUNICATION DEVICE AND ASSOCIATED CONTROL METHOD

(71) Applicant: Realtek Semiconductor Corp., HsinChu (TW)

(72) Inventor: Chien-Hung Liao, HsinChu (TW)

(73) Assignee: Realtek Semiconductor Corp., HsinChu (TW)

(21) Appl. No.: 17/710,991

(22) Filed: Mar. 31, 2022

(30) Foreign Application Priority Data
May 4, 2021 (TW) 110116014

(51) Int. Cl. H04W 36/16; H04W 72/08; H04W 76/15; H04W 36/00

(52) U.S. Cl. CPC H04W 36/165; H04W 72/085; H04W 76/15; H04W 36/0069

(57) ABSTRACT

The present invention provides a control method of a communication device, wherein the control method includes the steps of: controlling a wireless communication module of the communication device to use a first channel to communicate with a wireless device; when the wireless communication module is using the first channel, detecting a plurality of channels to generate a plurality of quality parameters, respectively; referring to the plurality of quality parameters to determine if the plurality of channels have a second channel whose quality parameter is better than the quality parameter of the first channel; and if there is the second channel whose quality parameter is better than the quality parameter of the first channel, selectively controlling the wireless communication module to use the second channel to communicate with the wireless device.

### BACKGROUND OF THE INVENTION

1. Field of the Invention

The present invention relates to a communication device.

2. Description of the Prior Art

In an access point (AP) or a router, an auto channel selection (ACS) mechanism is executed when the device is powered on to select a better channel for subsequent wireless communication. However, because the ACS mechanism is only executed when the access point or router is powered on, and the access point or router does not restart frequently after it is powered on, the access point or router usually use the same channel for wireless communication. Therefore, if the surrounding environment of the access point or router changes, it is very likely that the signal quality of this channel will deteriorate. At this time, the access point or router has no mechanism to choose another channel for the wireless communication, and the performance of the access point or router will be worsened and cannot be improved immediately.

Furthermore, the ACS mechanism only detects signals from other wireless communication devices for determining the better channel, and the ACS mechanism does not consider other sources of interference, such as microwave interference from microwave ovens, and interference from these other sources may just have a serious impact on the signal quality of the current channel. Therefore, if the access point or router only uses the channel selected by the ACS mechanism for wireless communication, it is likely to affect its throughput due to interference from these other sources.

### SUMMARY OF THE INVENTION

It is therefore an objective of the present invention to provide a communication device having channel detection mechanism, which can perform channel detection to determine the quality of each channel when the communication device is communicating with other devices, so that the communication device can determine if switching to a better channel for wireless communication, to solve the above-mentioned problems.

In one embodiment of the present invention, a control method of a communication device comprises the steps of: controlling a wireless communication module of the communication device to use a first channel to communicate with a wireless device; when the wireless communication module is using the first channel, detecting a plurality of channels to generate a plurality of quality parameters, respectively; referring to the plurality of quality parameters to determine if the plurality of channels have a second channel whose quality parameter is better than the quality parameter of the first channel; and if there is the second channel whose quality parameter is better than the quality parameter of the first channel, selectively controlling the wireless communication module to use the second channel to communicate with the wireless device.

In another embodiment, a communication device comprising a wireless communication module, a processor and a channel detection module is disclosed, wherein the processor is configured to control the wireless communication module to use a first channel to communicate with a wireless device, and the channel detection module is configured to detect a plurality of channels to generate a plurality of quality parameters when the wireless communication module is using the first channel to communicate with the wireless device. In addition, the processor refers to the plurality of quality parameters to determine if the plurality of channels have a second channel whose quality parameter is better than the quality parameter of the first channel; and if there is the second channel whose quality parameter is better than the quality parameter of the first channel, the processor selectively controls the wireless communication module to use the second channel to communicate with the wireless device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a communication device according to one embodiment of the present invention.

FIG. 2 a diagram of a channel load measurement.

FIG. 3 is a diagram of noise histogram measurement.

FIG. 4 is a flowchart of a control method of a communication device according to one embodiment of the present invention.

### DETAILED DESCRIPTION

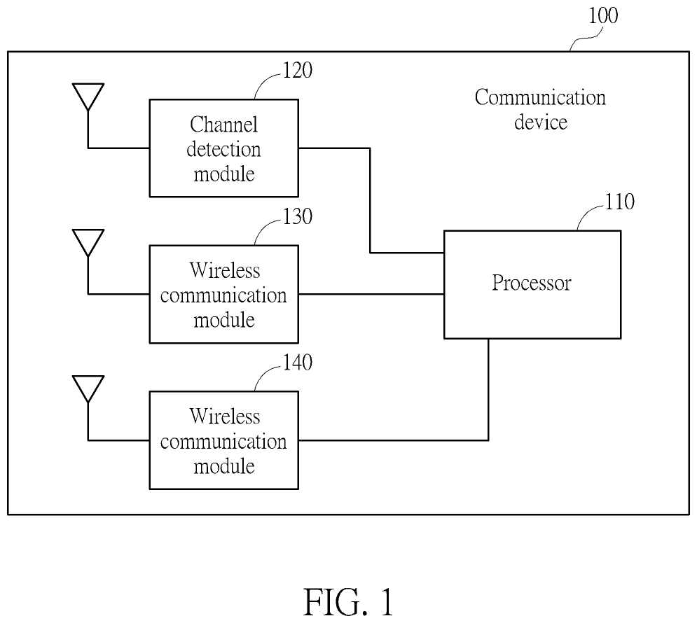

FIG. 1 is a diagram illustrating a communication device 100 according to one embodiment of the present invention. As shown in FIG. 1, the communication device 100 comprises a processor 110, a channel detection module 120 and two wireless communication modules 130 and 140. In this embodiment, the communication device 100 is an access point or a router, and the wireless communication module 130 is used to transmit and receive signals in 2.4 GHz channels, and the wireless communication module 140 is used to transmit and receive signals in 5 GHz channels.

In the operation of the communication device 100, when the communication device 100 is powered on and has performed an ACS mechanism to select one or two channels, the processor 110 will control the wireless communication module 130 to use the determined channel for wireless communication, or control the wireless communication module 140 to use the determined channel for wireless communication; or the processor 110 will control the wireless communication module 130 to use the determined channel for wireless communication, and control the wireless communication module 140 to use another determined channel for wireless communication. After the communication device 100 completes the above operations, the channel detection module 120 starts to perform real-time channel detection to generate channel information, so as to determine the quality of each channel. Then, the processor 110 determines whether to switch the channel currently used by the wireless communication module 130 or the wireless communication module 140 to another channel to have better communication quality.

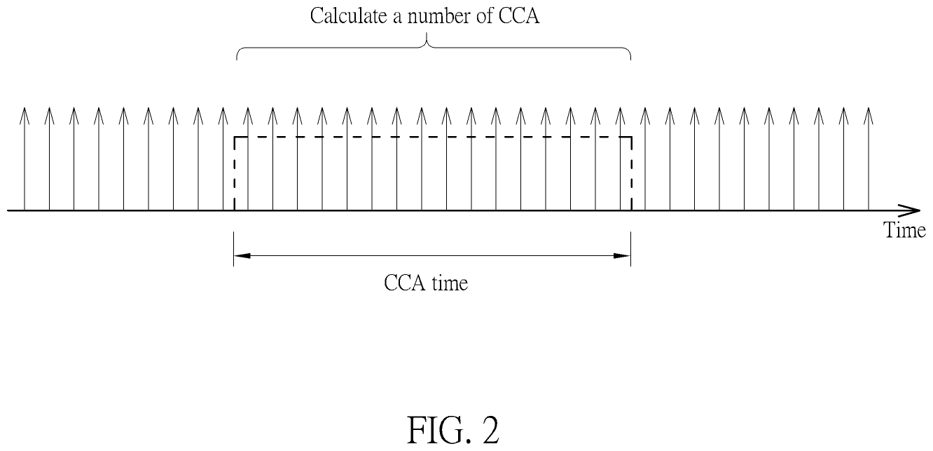

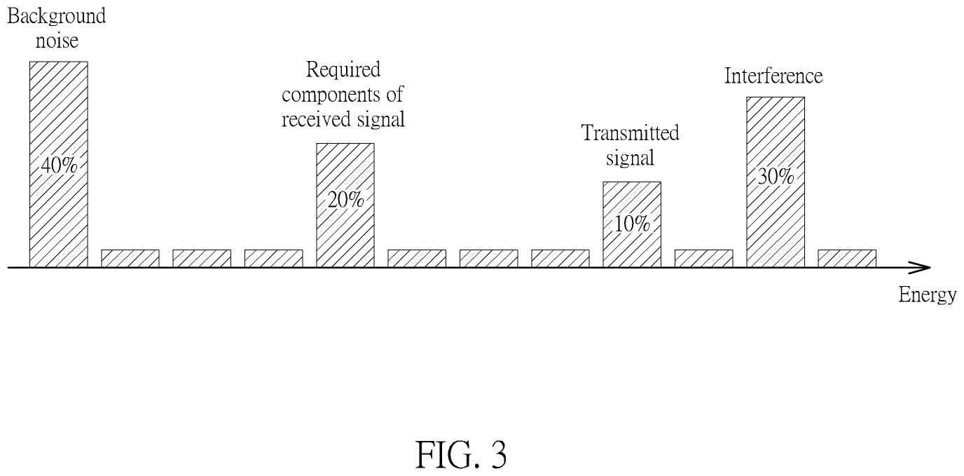

Specifically, the channel detection module 120 may have a dedicated antenna, so that when the wireless communication module 130 and the wireless communication module 140 are operating, the channel information of each channel can still be detected. In one embodiment, the channel detection module 120 may be a wireless communication module, and its structure may be similar to the wireless communication modules 130 and 140. In the operation of the channel detection module 120, the channel detection module 120 will periodically detect each channel to generate corresponding channel information, for example, the channel detection module 120 receives the signal of each channel every 30 seconds to generate corresponding channel information. For example, the channel detection module 120 can detect each channel by using a channel load measurement (CLM) and/or a noise histogram measurement (NHM). The channel load measurement method can refer to FIG. 2, that is, for each channel, the channel detection module 120 calculates a number of channel idle times or an idle time during a clear channel assessment (CCA) time to determine a percentage of time that the communication device 100 can actually receive packets. The noise histogram measurement method can refer to FIG. 3, which comprises the energy ratio of the content received by a channel in a period of time, such as background noise, required components of received signal, transmitted signal, interference signals, . . . etc. from different sources. In the above example, because the channel load measurement can determine the proportion of time that the communication device 100 can actually receive packets when the channel is used, it can accurately reflect whether there are other devices around the communication device 100 use this channel or a similar frequency band (for example, 2.492 GHz-2.480 GHz used by Bluetooth devices). In addition, because the noise histogram measurement can detect environmental noise, it can accurately reflect whether there is a microwave oven or other microwave devices operating around the communication device 100. As mentioned above, the above two channel information can accurately reflect the quality of the channel.

Then, after the channel information of each channel is generated, the channel detection module 120 can determine the quality of each channel according to the channel information. For example, the channel detection module 120 can calculate the quality parameters of some channels as shown in Table 1 below.

TABLE 1

| | Quality | | |
|---|---|---|---|
| | parameter | | |
| channel | % | CLM (%) | NHM (%) |
| 1 | 52 | 73 | 25 |
| 2 | 74 | 20 | 32 |
| 3 | 52 | 25 | 73 |
| 4 | 51 | 40 | 59 |
| 5 | 51 | 32 | 66 |
| 6 | 51 | 76 | 23 |
| 7 | 47 | 34 | 64 |
| 8 | 51 | 27 | 72 |
| 9 | 51 | 32 | 67 |
| 10 | 51 | 74 | 24 |
| 11 | 51 | 90 | 8 |
| 12 | 51 | 56 | 42 |
| 13 | 38 | 9 | 89 |
| 36 | 77 | 26 | 20 |
| 40 | 67 | 16 | 50 |
| 44 | 62 | 39 | 39 |
| 48 | 56 | 35 | 54 |
| 52 | 59 | 64 | 30 |
| 56 | 66 | 80 | 12 |
| 60 | 68 | 74 | 12 |
| 64 | 54 | 92 | 0 |
| 100 | 86 | 13 | 16 |
| 104 | 75 | 19 | 33 |
| 108 | 74 | 26 | 26 |
| 112 | 66 | 39 | 31 |
| 116 | 65 | 16 | 54 |
| 120 | 69 | 11 | 52 |
| 124 | 72 | 25 | 33 |
| 128 | 60 | 28 | 52 |
| 132 | 70 | 11 | 50 |

It should be noted that Table 1 is for illustrative purpose only. In practice, the channel detection module 120 can generate more different channel information for use in generating quality parameters, and different weights can be set for different channel information to calculate quality parameters.

In the above embodiments, the channel detection module 120 periodically generates channel information and quality parameters. However, the present invention is not limited to this. In another embodiment, the channel load measurement and the noise histogram measurement will be affected by the operation of the wireless communication module 130 and the wireless communication module 140, that is, if the wireless communication module 130 is using a first channel to transmit and receive data, the channel load measurement and noise histogram measurement will have errors for the first channel due to the signal component/intensity of the first channel. In order to solve this problem, the processor 110 may first notify the channel detection module 120 of the information about the first channel being used by the wireless communication module 130 (for example, the time when the wireless communication module 130 transmits a signal), and the channel detection module 120 will pre-deduct the component/intensity of the first channel when calculating the channel load measurement and the noise histogram measurement, so that the channel information calculation of the first channel can be more accurate. Similarly, the processor 110 may first notify the channel detection module 120 of the information about the channel being used by the wireless communication module 140, and the channel detection module 120 will pre-deduct the component/intensity of the channel when calculating the channel load measurement and the noise histogram measurement, so that the channel information calculation of the channel can be more accurate. In another embodiment, the processor 110 may notify the channel detection module 120 about the time when the wireless communication module 130 and the wireless communication module 140 transmit data, and the channel detection module 120 may select a period that the wireless communication module 130 and the wireless communication module 140 do not transmit data to perform channel detection to generate the channel information. In another embodiment, the processor 110 may transmit a trigger signal at a time when the wireless communication module 130 and the wireless communication module 140 are not transmitting data to trigger the channel detection module 120 to perform channel detection to generate the channel information.

After calculating the quality parameters, the processor 110 determines whether the quality parameter of the channel currently used by the wireless communication module 130 or the wireless communication module 140 is lower than the quality parameters of other channels to determine whether to switch the wireless communication module 130 or the wireless communication module 140 to another channel. For example, channel ‘1’-channel ‘13’ correspond to 2.4 GHz band, and assuming that the wireless communication module 130 is using channel ‘1’ to communicate with other wireless devices, and the processor 110 determines that the channel ‘11’ has the best quality parameter, the processor 110 can control the wireless communication module 130 to switch to channel ‘11’ from channel ‘1’ to communicate with other wireless devices. In another example, assuming that the wireless communication module 140 is using the channel ‘60’ to communicate with other wireless devices, and the processor 110 determines that the channel ‘132’ has the best quality parameters, the processor 110 can control the wireless communication module 140 to switch to channel ‘132’ to communicate with other wireless devices. In addition, since the channel switching operation of the communication device 100 can be obtained by referring to the content of the IEEE 802.11 k specification, the relevant details will be omitted here.

It should be noted that the mechanism for the processor 110 to determine whether to control the wireless communication module 130 or the wireless communication module 140 to switch to another channel may have the following other implementations. First, since the communication device 100 requires a more complicated process when performing channel switching, the processor 110 may perform channel switching operation only when the quality parameter of the channel currently used by the wireless communication module 130 or the wireless communication module 140 is lower than a threshold value. Second, the processor 110 may perform channel switching operation only when a difference between the quality parameter of the channel currently used by the wireless communication module 130 or the wireless communication module 140 and an optimal quality parameter is greater than a threshold value. Third, the processor 110 determines whether the wireless communication module 130 or the wireless communication module 140 is currently performing massive or continuous data transmission with other wireless devices, and the processor 110 does not perform channel switching operation if the wireless communication module 130 or the wireless communication module 140 is busy.

In another embodiment, one of the wireless communication module 130 and the wireless communication module 140 can be removed from the communication device 100 without affecting the spirit of the present invention.

In another embodiment, when the processor 110 determines that a better channel is currently available for the wireless communication module 130 or the wireless communication module 140, the processor 110 first transmits the channel switching information of the wireless communication module 130 or the wireless communication module 140 to the user/manager for reference, without directly performing channel switching operation. In addition, the user can determine if controlling the communication device 100 to switch the channel according to the channel switching information from the communication device 100.

In the above embodiments, the channel detection module 120 is used to detect channel information and determine the quality parameter of each channel, however, the present invention is not limited to this. In other embodiments, the channel detection module 120 may only be used to generate channel information, and the processor 110 receives the channel information from the channel detection module 120 and then calculates the quality parameter of each channel.

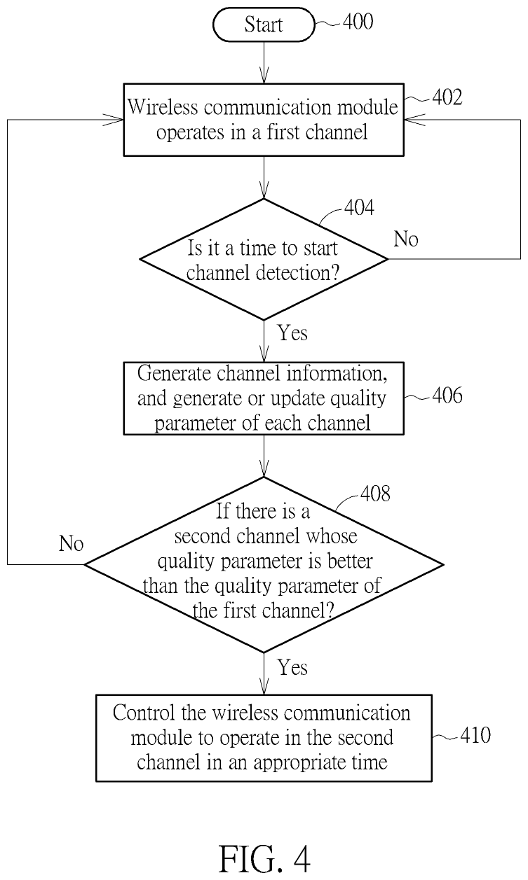

FIG. 4 is a flowchart of a control method of a communication device according to one embodiment of the present invention. Referring to the above embodiments, the flow of the control method is as follows.

Step 400: the flow starts.

Step 402: the wireless communication module operates in a first channel.

Step 404: determine whether it is a time to start channel detection, if yes, the flow enters Step 406; and if not, the flow goes back to Step 402.

Step 406: generate channel information and generate or update quality parameter of each channel.

Step 408: determine if there is a second channel whose quality parameter is better than the quality parameter of the first channel, if yes, the flow enters Step 410; and if not, the flow goes back to Step 402.

Step 410: control the wireless communication module to operate in the second channel in an appropriate time.

Briefly summarized, in the communication device and associated control method, the channel detection is performed when the wireless communication is communicating with other devices to generate the quality parameters of channels, then the communication device determines whether to switch the channel that the wireless communication module is using according to the quality parameters of channels. Therefore, the present invention can ensure that the communication device always uses a channel with better quality to communicate with other wireless devices, so as to improve the overall communication quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of a communication device, comprising:
controlling a wireless communication module of the communication device to use a first channel to communicate with a wireless device;
when the wireless communication module is using the first channel, detecting a plurality of channels to generate a plurality of quality parameters, respectively;
referring to the plurality of quality parameters to determine if the plurality of channels have a second channel whose quality parameter is better than the quality parameter of the first channel; and
if there is the second channel whose quality parameter is better than the quality parameter of the first channel, selectively controlling the wireless communication module to use the second channel to communicate with the wireless device.

2. The control method of claim 1, wherein the step of detecting the plurality of channels to generate the plurality of quality parameters, respectively comprises:
when the wireless communication module is using the first channel, periodically detecting the plurality of channels to generate the plurality of quality parameters, respectively.

3. The control method of claim 1, wherein the step of detecting the plurality of channels to generate the plurality of quality parameters, respectively comprises:
when the wireless communication module is using the first channel, referring to a time when the wireless communication module transmits data to select a period that the wireless communication module does not transmit data to detect the plurality of channels to generate the plurality of quality parameters, respectively.

4. The control method of claim 1, wherein the step of detecting the plurality of channels to generate the plurality of quality parameters, respectively comprises:
when the wireless communication module is using the first channel, starting detecting the plurality of channels according to a trigger signal to generate the plurality of quality parameters, respectively, wherein the trigger signal indicates the time when the wireless communication module does not transmit data.

5. The control method of claim 1, wherein the step of detecting the plurality of channels to generate the plurality of quality parameters, respectively comprises:
when the wireless communication module is using the first channel, performing a channel load measurement (CLM) and/or a noise histogram measurement (NHM) on each of the plurality of channels; and
calculating the quality parameter of each channel based on results of the channel load measurement and/or the noise histogram measurement.

6. The control method of claim 1, wherein the step of detecting the plurality of channels to generate the plurality of quality parameters, respectively comprises:
when the wireless communication module is using the first channel, using a channel detection module different from the wireless communication module to detect the plurality of channels to generate the plurality of quality parameters, respectively.

7. The control method of claim 1, wherein the step of selectively controlling the wireless communication module to use the second channel to communicate with the wireless device comprises:
determining if the wireless communication module is busy using the first channel;
if the wireless communication module is busy using the first channel, not controlling the wireless communication module to switch to the second channel from the first channel; and
if the wireless communication module is not busy using the first channel, controlling the wireless communication module to switch to the second channel from the first channel, and using the second channel to communicate with the wireless device.

8. The control method of claim 1, wherein the communication device is an access point or a router.

9. A communication device, comprising:
a wireless communication module;
a processor, configured to control the wireless communication module to use a first channel to communicate with a wireless device; and
a channel detection module, configured to detect a plurality of channels to generate a plurality of quality parameters when the wireless communication module is using the first channel to communicate with the wireless device;
wherein the processor refers to the plurality of quality parameters to determine if the plurality of channels have a second channel whose quality parameter is better than the quality parameter of the first channel; and if there is the second channel whose quality parameter is better than the quality parameter of the first channel, the processor selectively controls the wireless communication module to use the second channel to communicate with the wireless device.

10. The communication device of claim 9, wherein when the wireless communication module is using the first channel, the channel detection module periodically detects the plurality of channels to generate the plurality of quality parameters, respectively.

11. The communication device of claim 9, wherein when the wireless communication module is using the first channel, the channel detection module refers to a time when the wireless communication module transmits data to select a period that the wireless communication module does not transmit data to detect the plurality of channels to generate the plurality of quality parameters, respectively.

12. The communication device of claim 9, wherein when the wireless communication module is using the first channel, the channel detection module starts detecting the plurality of channels according to a trigger signal to generate the plurality of quality parameters, respectively, wherein the trigger signal indicates the time when the wireless communication module does not transmit data.

13. The communication device of claim 9, wherein when the wireless communication module is using the first channel, the channel detection module performs a channel load measurement (CLM) and/or a noise histogram measurement (NHM) on each of the plurality of channels, then the channel detection module or the processor calculates the quality parameter of each channel based on the results of the channel load measurement and/or the noise histogram measurement.

14. The communication device of claim 9, wherein the processor determines if the wireless communication module is busy using the first channel, and if the wireless communication module is busy using the first channel, the processor does not control the wireless communication module to switch to the second channel from the first channel; and if the wireless communication module is not busy using the first channel, the processor controls the wireless communication module to switch to the second channel from the first channel, and the wireless communication module uses the second channel to communicate with the wireless device.

15. The communication device of claim 9, wherein the communication device is an access point or a router.
